(19) United States
(12) Patent Application Publication
(10) Pub. No.: US 2021/0172750 A1
(43) Pub. Date: Jun. 10, 2021

(54) METHOD OF DETERMINING POLLUTANT AND/OR NOISE EMISSIONS AND/OR ROAD SAFETY PARAMETERS ON A ROAD NETWORK PORTION

(71) Applicant: IFP Energies nouvelles, Rueil-Malmaison Cedex (FR)

(72) Inventors: Giovanni DE NUNZIO, RUEIL-MALMAISON CEDEX (FR); Guillaume SABIRON, RUEIL-MALMAISON CEDEX (FR); Laurent THIBAULT, RUEIL-MALMAISON CEDEX (FR)

(21) Appl. No.: 17/116,754

(22) Filed: Dec. 9, 2020

(30) Foreign Application Priority Data
Dec. 9, 2019 (FR) 19/13.993

(51) Int. Cl. G01C 21/34; G01C 21/36; G08G 1/00; G08G 1/01

(52) U.S. Cl. CPC G01C 21/3469; G01C 21/3461; G08G 1/0116; G08G 1/20; G01C 21/367

(57) ABSTRACT

The present invention relates to a method of determining physical parameters (Phy) relative to pollutant and/or noise emissions and/or road safety of a vehicle fleet (P1) on a road portion. The method comprises the following steps:
a) measuring (MES) the positions (pos_{GPS}), speeds (v_{GPS}) and altitudes (alt_{GPS}) of vehicles on the road portion so as to determine (DET1) a speed profile (pv),
b) determining (DET2) at least one physical characteristic (Tab) on the road portion for each of the fleet vehicles, according to the characteristics (PAR) of these vehicles and to the speed profile (pv) determined in step a),
c) applying (APP) the fleet to the physical characteristics determined in the previous step to obtain a distribution (Rep) of the physical characteristics on the fleet,
d) determining (DET3) physical parameter (Phy) on the part of the road network portion by means of distribution (Rep) of the physical characteristics obtained in step c).

### FIELD OF THE INVENTION

The invention concerns the characterization of pollutant and/or noise emissions and/or road safety parameters of a road network portion.

### BACKGROUND OF THE INVENTION

According to the World Health Organization (WHO), about 18,000 deaths per day can be attributed to poor air quality, which brings the estimate to about 6.5 million deaths per year. Air pollution also represents a major financial issue: according to a Senate committee of inquiry, the total estimated cost of air pollution ranges between 68 and 97 billion Euros per year in France, as assessed in July 2015, considering both the health damage caused by pollution and its consequences on buildings, ecosystems and agriculture.

The transport sector still represents a major source of emissions despite the many measures taken by the public authorities and the technological advances in the field. Transport, across all modes, is responsible for about 50% of global nitrogen oxides (NOx) emissions and about 10% of PM2.5 (Particulate Matter of less than 2.5 μm in diameter) emissions. Road transport alone makes a significant contribution to transport-related emissions, with 58% of the NOx emissions and 73% of the PM2.5 emissions.

These emissions are mainly due to three factors: exhaust emissions, abrasion emissions and evaporative emissions. Although heavy-duty trucks are the main pollutant emitters, passenger vehicles, which are more present in densely populated urban areas, have the highest impact on citizens' exposure to poor air quality.

Measures taken locally for transport management (such as better transport planning and incentives for modal shift), as well as progressive fleet renewal, have contributed to limiting exhaust gas emissions from road transport in cities and urban areas. Indeed, worldwide, the road transport activity has increased by a quarter in the last decade, but NOx and particulate emissions have respectively increased by 5% and decreased by 6%. Despite such improvements, the pollution levels still exceed the thresholds set by the WHO in many cities.

Currently, the services responsible for the operational application of transport policies do not have the necessary tools enabling them to know the impacts of road developments in terms of pollutant emissions, noise and road safety. Decisions such as speed limit modification, setting up of traffic-light crossroads or of speed bumps have a direct and significant impact on the speed and acceleration of vehicles, therefore on their pollutant and noise emissions. To date, these impacts are not known and they are therefore not taken into account by the cities.

This lack of knowledge is closely related to the difficulty of collecting real representative data allowing these impacts to be assessed. Today, new digital technologies offer an opportunity to solve this problem. It is indeed possible to collect much more easily a large volume of real mobility data (for example GPS or Global Positioning System type records of the daily trips of thousands of individual drivers, also referred to as FCD or Floating Car Data).

The literature shows that it is possible today to characterize emissions (L. Thibault, P. Degeilh, O. Lepreux, L. Voise, G. Alix, G. Corde, “A new GPS-based method to estimate real driving emissions”, in IEEE 19th International Conference on Intelligent Transportation Systems, 2016), noise (C. Asensio, J. M. López, R. Pagán, I. Pavón, and M. Ausejo, “GPS-based speed collection method for road traffic noise mapping,” Transp. Res. Part D Transp. Environ., vol. 14, no. 5, pp. 360-366, 2009) and ground adhesion (R. Vaiana et al., “Driving behavior and traffic safety: an acceleration-based safety evaluation procedure for smartphones,” Mod. Appl. Sci., vol. 8, no. 1, p. 88, 2014) from GPS signals.

The following models are notably known: the Comprehensive Modal Emission Model (CMEM) (M. Barth, “The Comprehensive Modal Emission Model (CMEM) for Predicting Light-Duty Vehicle Emissions,” in Transportation Planning and Air Quality IV: Persistent Problems and Promising Solutions, 2000, pp. 126-137), the Passenger car and Heavy duty Emission Model (PHEM) (S. Hausberger, M. Rexeis, M. Zallinger, and R. Luz, “PHEM User guide for version 10,” TUG/FVT Rep., pp. 1-57, 2010) and the Virginia Tech Microscopic energy and emission model (VT-Micro) (H. Rakha, K. Ahn, and A. Trani, “Development of VT-Micro model for estimating hot stabilized light duty vehicle and truck emissions,” Transp. Res. Part D Transp. Environ., vol. 9, no. 1, pp. 49-74, 2004).

However, these few existing air quality monitoring tools do not allow to precisely estimate the proportion of pollutant and/or noise emissions, or the impact on road safety in actual use, or to precisely determine their location in space. Indeed, in these methods, emissions assessment is based on an average speed on road segments of several kilometers, as in the COPERT methodology (COmputer Program to calculate Emissions from Road Transports, a program funded by the European environment agency, http://emisia.com/products/copert). These methods thus do not take account of the existing acceleration/deceleration phases on these segments, whereas these phases generate high pollutant and/or noise emissions and may have an impact on road safety, notably due to lack of ground adhesion of the vehicle.

Furthermore, the technological specificities of the vehicles are not correctly taken into account, notably for recent diesel vehicles, which leads to significant errors.

It is therefore difficult for cities to make the right decisions as regards road infrastructure development without the specific tools for assessing these impacts in terms of pollution, noise and/or road safety.

Considering the lack of such tools, some communities directly make infrastructure or road network regulation modifications, and they optionally carry out an a posteriori study on the pollutant and/or noise emissions, and/or the risks in terms of road safety.

When it is carried out, this a posteriori study is in some cases quantitative and, in others, only qualitative.

When it is quantitative, pollutant/noise emissions and/or road safety risk measurements are then performed in connection with these changes. However, these measurements remain very local and they do not allow to precisely define the impact on the road network portion, and they do notably not allow to assess the local variations. Furthermore, these measurements are expensive. They represent a significant cost for the communities.

When it is qualitative, the study is restricted to an approach based notably on users' and local residents' reviews. This approach is therefore subjective and unreliable.

Irrespective of how the a posteriori study is carried out, infrastructure modifications are very expensive. Now, performing infrastructure modifications and optionally an a posteriori study involves a significant cost for the communities. If the study shows that the infrastructure has not improved anything or has even worsened the situation, a new modification may appear necessary. The costs incurred may therefore be very high with such a trial and error method before a satisfactory solution is found. Furthermore, the studies conducted are not precise and they rarely enable to assess the impact of the modifications brought on several criteria (pollution, noise and road safety for example).

In order to avoid unnecessary infrastructures or regulations, as well as imprecise and incomplete studies, it is therefore necessary to be able to precisely determine the pollutant and/or noise emissions and the risks in terms of road safety for a road network portion, notably in the case of infrastructure or regulation changes on these portions, without having to make these changes physically beforehand.

In order to meet these challenges, the invention relates to a method of determining physical parameters relative to pollutant and/or noise emissions and/or road safety of a vehicle fleet on a road network portion. The method uses at least one means of measuring positions, speeds and/or altitudes on the road network portion. Furthermore, it comprises the following steps, preferably implemented by computer means:

a) measuring at least the positions, speeds and/or altitudes using the measuring means on the road network portion and determining a speed profile on the road network portion,
b) determining at least one physical characteristic on at least part of the road network portion for each of the fleet vehicles, according to the characteristics of these vehicles and to the speed profile determined in step a),
c) applying the fleet to the physical characteristics determined in the previous step to obtain a distribution of the physical characteristics on the fleet,
d) determining the physical parameter on the part of the road network portion by means of the distribution of the physical characteristics obtained in step c).

### SUMMARY OF THE INVENTION

The invention relates to a method of determining physical parameters relative to pollutant and/or noise emissions and/or road safety of a predefined fleet of predetermined vehicles on a road network portion, the method using at least one means of measuring positions, speeds and altitudes on said road network portion. Furthermore, the method comprises the following steps:

a) measuring at least the positions, speeds and/or altitudes using said at least one measuring means on said road network portion and determining a speed profile on said road network portion,
b) determining at least one physical characteristic on at least part of said road network portion for each of said predetermined vehicles of said predefined fleet, according to the characteristics of said predetermined vehicles and to the speed profile thus determined,
c) applying said predefined fleet to said physical characteristics determined in the previous step to obtain a distribution of said physical characteristics on said predefined fleet,
d) determining said physical parameter on at least said part of said road network portion by means of said distribution of said physical characteristics obtained in step c).

Preferably, a spatial aggregation of the measured positions is performed.

Advantageously, the spatial aggregation comprises a correction of the measured positions so as to correspond to positions of said road network portion.

According to an implementation of the invention, said road network portion is divided into segments of predetermined length, and steps b), c) and d) are carried out on each of said segments of predetermined length.

According to a preferred embodiment of the invention, in step d), said physical parameter is determined on at least said road network portion by aggregating said distribution of said physical characteristics obtained in step c).

Preferably, when said aggregation of the distribution of said physical parameters is performed, said physical parameter is taken as the value of said distribution of said physical characteristics corresponding to a predetermined quantile, the predetermined quantile preferably being the sixtieth percentile.

Advantageously, said physical parameter comprises the amount of NOx emissions, the amount of PM2.5 emissions, the amount of greenhouse gas emissions, the noise emissions and/or a variable representative of the impact on road safety of said part of said road network portion, preferably the variable representative of the impact on road safety being the adhesion to said part of the road network portion.

According to an embodiment of the invention, said physical characteristics comprise the amount of NOx emissions, the amount of PM2.5 emissions, the amount of greenhouse gas emissions, the noise emissions and/or a variable representative of the impact on road safety of each predetermined vehicle on said part of said road network portion, preferably the variable representative of the impact on road safety being the adhesion of said predetermined vehicle to said part of the road network portion.

Advantageously, the characteristics of the predetermined vehicles comprise the mass of the vehicles, the engine type and the exhaust gas aftertreatment type.

In a variant of the method according to the invention, a traffic stream is applied, said traffic stream preferably comprising the flow of vehicles on said road network portion, according to the day and the time of day considered.

According to an embodiment of the invention, said physical parameter is displayed on a road map, preferably by means of a smartphone, a computer, a digital tablet or a computer system.

Preferably, said physical parameter is displayed on a road map for a configuration chosen by the user, and said configuration can comprise said physical parameter to be displayed, the predefined fleet of predetermined vehicles, the sensitivity level of said physical parameter, the predetermined quantile and/or the traffic stream.

In a variant of the invention, a confidence parameter is determined for said physical parameter.

In a preferred embodiment of the invention, in step b), for each predetermined vehicle, at least one characteristic of the predetermined vehicle relative to the design of said vehicle is acquired and the following models are constructed for said vehicle:

i) a model of said vehicle relating at least the speed profile to the torque and the speed of said engine by means of at least one characteristic of the predetermined vehicle,
ii) a model of said engine relating said torque and said speed of said engine to the pollutant and/or noise emissions at the outlet of said engine by means of at least one characteristic of the predetermined vehicle, and
iii) a model of said aftertreatment system relating said pollutant and/or noise emissions at the outlet of said engine to the pollutant and/or noise emissions at the outlet of said aftertreatment system by means of at least one characteristic of said predetermined vehicle,
and said torque and said speed of said engine are determined by means of said vehicle model and said speed profile; the pollutant and/or noise emissions at the outlet of said engine are determined by means of said engine model and said torque and said speed of said engine; and the pollutant and/or noise emissions of the vehicle are determined by means of said aftertreatment system model and said pollutant and/or noise emissions at the outlet of said engine, said physical characteristics being the pollutant and/or noise emissions at the aftertreatment system outlet.

The invention also relates to a computer program product downloadable from a communication network and/or recorded on a computer-readable medium and/or processor or server executable, comprising program code instructions for implementing the method according to any one of the above features, when said program is executed on a computer, a mobile phone or a computer device.

The invention further relates to the use of the method according to one of the features described above for modifying the road infrastructure, extending the public transport network and/or modifying the road traffic control measures.

### BRIEF DESCRIPTION OF THE FIGURES

Other features and advantages of the device and/or the product according to the invention will be clear from reading the description hereafter of embodiments given by way of non-limitative example, with reference to the accompanying figures wherein:

FIG. 1 shows the steps of the method according to an embodiment of the invention,

FIG. 2 illustrates an example of a histogram showing the distribution of the physical characteristics according to the invention,

FIG. 3 shows the steps of determining the physical parameters of the pollutant emissions according to the invention,

FIG. 4 shows a first example of display of NOx emissions on a road network portion on the road map, from the method according to the invention,

FIG. 5 shows a second example of display of NOx emissions on a road network portion on the road map, from the method according to the invention, this second example differing from the example of FIG. 4 by the addition of a second traffic light,

FIG. 6 shows an example of display of NOx emissions on a road network portion on the road map, identical to FIGS. 4 and 5, from the COPERT method of the prior art, and

FIG. 7 illustrates an embodiment of step b) of the method according to the invention.

### DETAILED DESCRIPTION OF THE INVENTION

The invention relates to a method of determining physical parameters representative of pollutant and/or noise emissions and/or road safety for a predefined fleet of predetermined vehicles on a road network portion. The physical parameter can be, for example:

for pollutant emissions: the amount of fine particulate matter emissions (PM2.5 for example), the amount of NOx emissions, the amount of greenhouse gas emissions (CO₂ for example), etc.,

for noise emissions: the estimated noise level in dB (decibel), etc., or

for road safety: the ground adhesion of vehicles in order to assess the impact on road safety, etc.

The object of this method is to determine at least one of these physical parameters on a road network portion, current or for modification, for example, addition of a traffic light, addition of a roundabout, maximum speed limit change, addition of a speed bump, or removal of a road network development.

The predefined fleet can be the current fleet of vehicles travelling along the road network portion. It can be defined by the user according to travel history records and/or to prior knowledge of the vehicle fleet in the zone considered. The predefined fleet can also be a future fleet, for the application of a future legislation (traffic ban on certain categories of vehicles, the oldest and/or the most polluting for example, access restricted to electric vehicles for example).

The predetermined vehicles are the vehicles used in the predefined fleet. They therefore depend on the fleet considered and they can be determined by the user of the method. Thus, the predefined fleet is a vehicle number or percentage distribution, for each predetermined vehicle travelling on the road network portion.

The method uses at least one means of measuring positions, speeds and/or altitudes on the road network portion. Preferably, the measuring means can notably be a GPS (Global Positioning System) geolocation system on board a vehicle or in a smartphone. This measuring means allows to measure at least the positions, speeds and altitudes of a vehicle on the road network portion. This measured data thus represents a record of achieved rides, referred to as FCD (Floating Car Data). Preferably, several positions, speeds and altitudes are measured on the same road network portion, so as to have more reliable measured data. Preferably, to give an order of magnitude, at least one hundred ride measurements are performed, each ride measuring the position, speed and altitude along the road network portion, so as to have reliable data.

Furthermore, the method comprises the following steps, preferably implemented by computer means:

a) measuring at least the positions, speeds and/or altitudes using the measuring means (a GPS for example) on the road network portion, preferably by means of several vehicles travelling on the road network portion. In other words, the position, speed and altitude data of vehicles travelling on the road network portion is recorded using the measuring means. A speed profile on the road network profile is then determined, notably from the measured speeds. For example, the speed profile can correspond to the average of the speeds recorded for each point of the road network portion. The speed profile is understood to be a speed variation along a road network portion or a part thereof. Each position, speed and altitude measurement corresponds to a vehicle ride achieved on the road network portion, the rides being achieved at different times (at different times means that the departure time at the departure point and/or the arrival time at the arrival point are different or at least that, on the road network portion, for two different rides, there is at least one crossing point crossed at two different times) and for the same or for different vehicles. Using different vehicles allows to diversify the data and thus to have a more reliable speed profile.

The speed profile can for example be determined by the average of the speeds measured at each point of the road network portion. The speed profile allows to take account of the acceleration and deceleration phases along the road network portion, which enables to improve the precision of the pollutant and noise emissions and the road safety.

The speed profile defines the speed of the vehicles at each position of the road network portion, and the position can be defined for example by latitude and longitude.

It is also possible to determine the slope variations of the road network portion, from the measured altitudes for example, by determining at each point of the road network portion the average altitude of the measured altitudes. Taking account of the slope variations allows this precision to be further improved, notably when the vehicle is on an uphill slope, the pollutant and noise emissions are higher than on a road portion with no slope or when the vehicle is on a downhill slope, the risk of adhesion loss is increased and the road safety thus is reduced;

b) determining (by calculating for example) at least one physical characteristic on at least part of the road network portion for each of the predetermined vehicles of the fleet, according to the characteristics of the predetermined vehicles, to the determined speed profile and possibly to the determined slope variations. A part of a road network portion is understood to be a road network portion divided into one or more zones. Thus, the physical characteristic can be determined over a short-length zone, for example by quantifying it, which allows to increase the spatial precision of the pollutant or noise emissions and/or the road safety. A physical characteristic is understood to be the amount of pollutant emissions, NOx, PM2.5 particulate matter or greenhouse gas such as CO₂ for example, the noise emissions level and/or the road safety risks such as the road adhesion level of each predetermined vehicle on the part of the road network portion concerned. For example, the pollutant emissions, the noise emissions or the adhesion level of each vehicle can be calculated from the speed profile determined in step a);
c) applying (or assigning) the fleet to the physical parameter determined in the previous stage so as to obtain a distribution of the physical characteristics on the predefined fleet, the fleet defining the number (or the percentage) of each predetermined vehicle. Applying the fleet enables to give a distribution of each physical characteristic representative of the number of each predetermined vehicle in the predefined fleet. Thus, each predetermined vehicle is associated with a value of the physical characteristic and a distribution (for example a percentage representative of the number of each predetermined vehicle in the predefined fleet) associated with this value of each physical characteristic. A distribution (also referred to as apportionment) of the various physical characteristics (each of the values depending on the predetermined vehicles) according to the predefined fleet of predetermined vehicles is thus obtained;
d) determining (or defining or calculating) the physical parameter in the part of the road network portion by means of the distribution of the physical characteristics obtained in step c). It is for example possible to determine the physical parameter by calculating a predetermined quantile, preferably the average or the sixtieth percentile of the distribution of the characteristics on the predefined fleet.

Therefore, the NOx, greenhouse gas such as CO₂, PM2.5 type particulate matter emissions, the noise level, the ground adhesion of the vehicle on the road network portion can be determined. It is thus possible to understand the impact of a vehicle fleet modification through a ban on the circulation or not of certain vehicles. It is also possible to assess the impact of a modification of a road infrastructure (addition of a traffic light, maximum speed limit change, addition of a roundabout, of a speed bump, etc.) on each physical parameter. These objective characteristics avoid physical completion of these infrastructure developments or road regulation modifications with a posteriori analyses and measurements for assessing the feedback, once the developments achieved. Indeed, on the one hand, these developments are very expensive for the communities (town, county or region) and, on the other hand, the analyses necessary for assessing these modifications are also expensive because they require setting up measuring means for quite long periods of time and post-treatment of the recorded data. Furthermore, the physical parameters determined by the method of the invention are objective data whereas currently, for lack of means providing quantitative analyses, the data is often subjective data provided by road portion users and/or local residents. The method according to the invention thus allows to save costs related to the physical completion of the infrastructures or road developments and to the analysis of the modifications provided. Moreover, it allows to determine from the objective data criteria such as pollutant emissions, noise emissions and road safety. Furthermore, by means of a multicriterion analysis, it provides a selection aid for infrastructure modification or road network development. An infrastructure is understood to be any physical element such as a traffic light, a crossroads, a roundabout, an acceleration/deceleration lane, the addition or removal of lanes, etc. Development is understood to be any regulation or traffic modification, for example maximum speed limit change, traffic light synchronization or not.

The physical aggregation parameter obtained corresponds to a physical parameter representative of the pollutant and/or noise emission and/or the road safety on the road network portion. For example, it can be considered as an average or the sixtieth percentile of the distribution of the physical characteristics of the predefined fleet on the road network portion.

Preferably, the position, speed and altitude measurements can be performed at an acquisition frequency ranging between 0.1 and 1000 Hz. Thus, the acquisition frequency is sufficient to enable precise location in space and to avoid excessive management of this acquisition data. This acquisition frequency can notably be obtained by means of GPS or some applications such as Geco Air™ (IFP Energies nouvelles, France).

More preferably yet, the acquisition frequency can range between 0.5 and 10 Hz. This configuration provides a good compromise between spatial precision and fast computation.

Preferably, spatial aggregation of the measured positions can be performed, for example by correcting the measured positions so that they correspond to positions of the road network portion. Indeed, imprecision of the measurements performed by FCD and/or GPS can lead to position data that is not on the road network portion concerned. Correction allows this imprecision to be reduced by artificially moving the positions onto the road network portion.

According to a preferred embodiment of the invention, the road network portion can be divided into segments of predetermined length, and the predetermined length can be defined by the user of the method or by the end user, for example, the local administrations, whether municipal, departmental and/or regional. This division into segments allows to improve the precision of the physical parameters (and of the physical characteristics), notably their spatial precision. It therefore provides finer estimation of a local increase or decrease of a physical parameter (and of a physical characteristic). The shorter the predetermined length, the greater the precision, notably spatial. Steps b), c) and d) can then be carried out on each segment of predetermined length, each of these segments then representing a part of the road network portion. Thus, it is possible to determine on each segment the physical characteristics and, therefore, the physical parameter. The local variations of these parameters can thus be assessed more precisely. The precision is thus improved.

According to an advantageous implementation of the invention, in step d), the physical parameter can be determined over at least part of the road network portion by aggregating the distribution of the physical characteristics obtained in step c). Indeed, step c) allows to obtain a distribution of the physical characteristics of the predefined fleet of predetermined vehicles on the part of the road network portion. An aggregation step allows to go from the distributed physical characteristics to a physical parameter that may preferably be a scalar, and this scalar can correspond to an objective value representative of the part of the road network portion. Alternatively, the physical parameter could represent a spatial distribution or a set of values, for example, the set of values could comprise a first scalar representing a determined quantile and a second scalar representing the standard deviation. This physical parameter thus characterizes the part of the road network portion in an objective, robust and precise way, in terms of pollutant emissions, noise emissions and/or road safety.

Preferably, aggregation of the distribution of the physical characteristics can be performed by taking the physical parameter as the value of the distribution of the physical characteristics corresponding to a predetermined quantile. In other words, by aggregating the distribution of the physical characteristics of step c), the aggregated physical parameter is the value of the distribution obtained in step c) for which the determined quantile of the distribution values is less than said value: the set of values of the distribution below the aggregated physical parameter represents the predetermined quantile. Using a quantile allows the aggregation precision to be refined and thus to obtain a reliable, robust and precise result.

Preferably, the predetermined quantile can be the sixtieth percentile. Thus, 60% of the values of the physical characteristic distribution obtained in step c) are below the aggregated physical parameter. Using the sixtieth percentile provides a good compromise in terms of precision and reliability for different road types and different vehicle types. Quantiles are values that divide a set of data into intervals containing the same number of data. The quantiles of a variable are the values taken by the variable for distribution values below the quantile considered. For example, q-quantiles are all the quantiles of the multiples of fraction 1/q. There are in total (q−1) q-quantiles. The p-th q-quantile of a variable X is thus defined as value x_{(p/q)} such that the values below x_{(p/q)} represent a fraction p/q of the distribution of X. In other words, for example, the distribution of a value of variable X below the p-th quantile x_{(p/q)} equal to p/q is:

$$P ( X \leq {x}_{( p / q )} ) = \frac{p}{q}$$

P being the distribution function of variable X.

Percentiles are the quantiles of the multiples of 1/100. Thus, the sixtieth percentile represents all the values of variable X such that they represent 60% of the distribution of X. In other words, the distribution of the sixtieth percentile can be written as follows:

P(X≤cent)= 60/100

Advantageously, the physical parameter of the pollutant and/or noise emissions and/or road safety can comprise the amount of pollutants emitted (NOx and/or PM2.5 type particulate matter for example), the amount of greenhouse gas emissions, the noise level and/or a variable representative of the impact on road safety (also referred to as road safety parameter), preferably the variable representative of the impact on road safety is adhesion to said part of the road network portion. Thus, the physical parameter of the pollutant and/or noise emissions and/or road safety is an objective datum representative of the pollution emitted, of the noise and/or the road safety resulting from the road network portion, notably through the infrastructures and developments thereof, and of the fleet of predetermined vehicles.

According to a configuration of the invention, the characteristics of the predetermined vehicles can comprise the mass of the vehicles, the engine type and the exhaust gas aftertreatment type. Thus, these characteristics allow to precisely define the pollutant and noise emissions, and the road adhesion for each predetermined vehicle type. The precision of the physical characteristics of each predetermined vehicle is thus improved. Therefore, the physical parameters relative to the pollutant and noise emissions and/or to the road safety are more precise.

According to an advantageous aspect of the invention, a traffic stream can be applied to the physical characteristic determined in step c), the traffic stream preferably comprising the flow of vehicles on the road network portion, according to the day and the time of day considered. The traffic stream allows to assess the impact during the day of the pollutant or noise emissions and/or of the road safety according to the flow of vehicles on the road network portion (or on a part of this portion).

The traffic stream can notably be determined by vehicle flows on the road network portion per time slot, for example every ten minutes. The traffic stream can therefore be measured for example during the day, preferably during several days. Data relative to the traffic and to the daily variation thereof is thus recorded during the day and collected.

According to another variant, the traffic stream can be determined by simulations representing a future traffic stream, for example from future public transport network developments or future traffic control measures.

Applying the traffic stream at the end of step c) provides more precise assessment of the hourly variations, for example, during the day, of the physical characteristics. To apply the traffic stream, each value of the distribution of the physical characteristics is multiplied by the flow of vehicles in the hourly and/or daily time slot concerned. After applying the traffic stream, step d) of aggregation of the distribution obtained after applying the traffic stream is carried out. Thus, the aggregated physical parameter obtained varies over time, for example per ten-minute slots. This enables to assess the impact of traffic congestion during the day on the pollutant and noise emissions or on the risks in terms of road safety.

According to an aspect of the invention, the physical parameter can be displayed on a road map, preferably by means of a smartphone, a computer, a tablet or a computer system. A map of the physical parameter that can be viewed by the user is thus obtained. This display allows to better identify the critical areas in which the pollutant or noise emissions and the risks related to road safety are centred. This map is also useful for assessing the impact of infrastructure or regulation changes on the road network portion (or a part of this portion). This map can also enable to simultaneously or successively view the impacts of pollutant and noise emissions and/or road safety risks. It therefore helps the user to choose an optimum compromise between these three criteria for modifying the infrastructure and/or the regulation in at least part of the road network portion.

Preferably, the physical parameter can be displayed on a road map for a configuration selected by the user. The configuration can comprise the physical parameter to be displayed, the predefined fleet of predetermined vehicles, the predetermined length of the segments when the road network portion is divided into segments, the sensitivity level of the physical parameter (the sensitivity level being the precision displayed, for example by increments of 200 mg/km for PM2.5 emissions), the predetermined quantile and/or the traffic stream. This allows to know the influence of the various parameters in order to increase the precision of the results obtained in terms of value and in terms of spatial location.

According to an advantageous implementation of the invention, a confidence parameter can be determined for the physical parameter. This confidence parameter notably depends on the number of position, speed and altitude measurements performed in step a), these measurements being used to determine the speed profile and the altitude variations of the road network portion. It may also depend on other parameters. It can be quantitative or qualitative.

This confidence parameter can also be displayed on the road map.

It allows the reliability of the results to be taken into account.

According to a preferred embodiment of the invention, in step b), for each predetermined vehicle, at least one characteristic of the predetermined vehicle relative to the design of each predetermined vehicle can be acquired and the following models are constructed for each predetermined vehicle:

i) a model of each predetermined vehicle relating the speed profile, and preferably the slope profile, to the torque and the speed of the engine of the predetermined vehicle by means of at least one characteristic of the predetermined vehicle (the mass of the vehicle, for example, and preferably the inertia thereof),
ii) a model of the engine of the predetermined vehicle relating the torque and the speed of the engine of the predetermined vehicle to the pollutant and/or noise emissions and/or the road safety risks at the engine outlet by means of at least one characteristic of the predetermined vehicle (for example, characteristics such as the engine type, diesel, gasoline, electric, displacement, performance, etc.), and
iii) a model of the aftertreatment system respectively relating the pollutant and/or noise emissions and/or the road safety risks at the engine outlet to the pollutant and/or noise emissions and/or road safety risks at the aftertreatment system outlet by means of at least one characteristic of the predetermined vehicle (for example, the technical characteristics of the aftertreatment system, aftertreatment performance for example),
and the engine torque and speed are determined by means of the vehicle model and of the speed profile (and preferably the slope profile); the pollutant and/or noise emissions and optionally the road safety risks at the engine outlet are determined by means of the engine model and of the engine torque and speed; and the pollutant and/or noise emissions and/or the road safety risks of the vehicle are determined by means of the aftertreatment system model and the pollutant and/or noise emissions and/or the road safety risks at the engine outlet.

The pollutant and/or noise emissions and/or the road safety risks of the vehicle at the outlet of the aftertreatment system correspond to the physical characteristics at the end of step b) of the method according to the invention.

Therefore, the pollutant and/or noise emissions and/or the road safety risks are precisely characterized for each predetermined vehicle by means of characteristics of the vehicle, the engine and the aftertreatment system(s). The precision of the physical parameter is thus improved on the road network portion.

Determining the Pollutant and/or Noise Emissions of Each Predetermined Vehicle

Vehicle Model

The vehicle model can for example relate the speed profile and preferably the slope profile to the torque and the speed of the engine of each predetermined vehicle, by means of at least one macroscopic parameter, for example the mass of the vehicle, the maximum power and the associated engine speed, the maximum speed, the transmission type, etc.

The vehicle model can combine a vehicle dynamics model and a vehicle transmission model. The vehicle dynamics model relates the speed profile and preferably the slope profile to the estimated vehicle power by means of at least one macroscopic parameter, for example the mass of the vehicle, the transmission type, the wheel dimensions. The vehicle transmission model relates the vehicle power to the engine speed and torque, by means of at least one macroscopic parameter, for example the transmission type, the maximum power and the associated engine speed.

The vehicle dynamics model takes account of the dynamics of the vehicle. It can be constructed from the application of the fundamental principle of the vehicle dynamics applied to the longitudinal axis thereof, and it can be written as follows:

$$m \frac{d v}{d t} = {F}_{T} - {F}_{r e s} - {F}_{s l o p e} - {F}_{b r k}$$

with
m: mass of the vehicle
t: time
v: speed of the vehicle, from the speed profile.

Fᵣₑₛ is the resultant force of the frictional forces undergone by the vehicle and it can be expressed as a function of speed in the form:

Fᵣₑₛ=a+bv+cv²

with a, b, c parameters of the vehicle to be identified according to the general characteristics of the vehicle (macroscopic parameters of the vehicle).
F_{T}: tractive effort on the wheels
F_{brk}: mechanical braking force
Fₛₗₒₚₑ: can be expressed as the mass of the vehicle and the slope profile of the road:

Fₛₗₒₚₑ=mg sin(b)

The inclination angle b is an input of the vehicle dynamics model. Indeed, inclination b can be calculated from the altitude and the distance travelled, it therefore depends on the slope profile.

These equations enable to write a formula relating the estimated power Pe of the engine to the speed of the vehicle and other macroscopic parameters, known or determinable. Indeed, the equation can be written as follows:

Pe=F_{T}*v/ηₜᵣₐₙₛ

with
ηₜᵣₐₙₛ: transmission efficiency
v: vehicle speed.

Thus, by combining the various equations, it is possible to determine a formula relating the engine power to the speed profile and possibly the slope profile, by means of known and constant macroscopic parameters.

The transmission model estimates the reduction ratio between the rotational speed of the thermal engine and the vehicle speed. It can be parametrized according to the general characteristics (macroscopic parameters) of the vehicle, notably the mass of the vehicle, the maximum power, the transmission type, in particular the number of gears. This transmission model uses only the speed of the vehicle as the input for estimating the reduction ratio:

$${R}_{MTH - v} = f ( \text{?} )$$

$$\text{?} \text{indicates text missing or illegible when filed}$$

Function f can be obtained notably from charts provided by the manufacturer. R_{MTH-v} is the reduction ratio between the rotational speed of the engine and the vehicle speed.

This reduction ratio can then be used to determine engine speed Ne. Indeed, the following relations can be written:

$$Ne = {R}_{MTH - v} * v$$

Engine torque Cme can then be determined as a function of the engine power (estimated by means of the vehicle dynamics model) and speed:

$$Cme = f 2 ( Ne , Pe )$$

Function f2 can be obtained from maps provided by the manufacturer.

Engine Model

The engine model relates the engine speed and torque to the pollutant and/or noise emissions at the engine outlet (i.e. before the aftertreatment system), by means of at least one macroscopic parameter. According to an implementation of the invention, at least one of the following macroscopic parameters can be used to construct the engine model: displacement, engine type, torque and power, air loop architecture, vehicle homologation standard, etc.

According to an embodiment of the invention, the engine model can be constructed by combination of an energy model and a model of pollutant and/or noise at the engine outlet. The energy model relates the engine torque and speed to fluid flow rates and temperatures in the internal-combustion engine (fuels, intake gas, exhaust gas, possibly burnt gas recirculation) by means of at least one macroscopic parameter, such as displacement, engine type, maximum torque and power, air loop architecture for example. The model of pollutant and/or noise level at the engine outlet relates the flow rates and temperatures of fluids in the internal-combustion engine to the pollutant and/or noise emissions at the engine outlet, by means of at least one macroscopic parameter, for example the vehicle homologation standard, the engine type, the air loop architecture.

The energy model allows to estimate physical quantities at the current operating point (engine speed, torque). It is parametrized according to macroscopic parameters. The estimated physical quantities are the flow rates and temperatures of fluids in the internal-combustion engine (fuels, intake gas, exhaust gas, possibly burnt gas recirculation).

The model of pollutant and/or noise level at the engine outlet allows to estimate, from the engine speed and torque data and the estimates from the energy model, the pollutant and/or noise emissions at the engine outlet. It can be parametrized according to the general characteristics of the vehicle and of the engine: vehicle homologation standard, engine type, air loop architecture, etc.

For example, estimation of the pollutants at the engine outlet can be achieved in two steps:

quasi-static emissions estimation by means of a quasi-static model, and

estimation of the impact of transient phenomena by means of a transient model.

Alternatively, estimation of the pollutants at the engine outlet can also be done in a single step by means of the quasi-static model.

Quasi-static emissions estimation of an engine at an operating point at a given instant amounts to considering that this engine runs under stabilized conditions at this operating point.

Estimation of the impact of transient phenomena (non-stabilized operation) allows to take account of the transient phenomena, which generally generate additional pollutant emissions.

Quasi-static pollutant models can be parametrized by means of macroscopic parameters of the vehicle and the engine. They make it possible to estimate at any instant the quasi-static pollutant emissions at the engine outlet, from the engine speed and torque estimates and the energy model outputs. The quasi-static models can be written as follows:

PSME_{i-QS}=ƒ3(Ne,Cme)

PSME_{i-QS}: emissions of pollutant i at the engine outlet for a quasi-static engine speed.

Function f3 can be of different types, depending on the type of pollutant studied.

For example, the quasi-static NOx model can be obtained from Gartner's work (U. Gartner, G. Hohenberg, H. Daudel and H. Oelschlegel, Development and Application of a Semi-Empirical NOx Model to Various HD Diesel Engines), and it can be written as follows:

log(NOxQS)=a0|a1*|a_{2*}mcyl|a₂*m_{O2}

Coefficients a₀, a₁, a₂, a₃ are obtained from experimental data. Nox_{QS} is the mass of NOx per unit mass of fuel; m_{cyl} the mass of air confined in the cylinder per cycle; m_{O2} the mass of oxygen confined in the cylinder per cycle.

One advantage of this model is that these coefficients vary little from one engine to the next. This point is demonstrated in the aforementioned article by Gartner.

The particles at the engine outlet are the combination of two phenomena: particle formation and post-oxidation in the combustion chamber. These phenomena are essentially influenced by the air/fuel ratio, the engine speed, the amount of fuel and the burnt gas ratio.

Similar models can be constructed for the other pollutants.

The means described below can be used to determine the impact of transient phenomena. Air loop dynamics phenomena generate a difference in the BGR ratios (burnt gas fraction related to the exhaust gas recirculation) and the air/fuel ratios in relation to the stabilized operating point, which has a strong impact on the pollutants, notably hydrocarbons HC, carbon monoxide CO and particulate matter. The transient impact models are parametrized according to macroscopic engine parameters, in particular the recovered air loop characteristics (atmospheric/supercharged, high-pressure exhaust gas recirculation EGR_{HP}/low-pressure exhaust gas recirculation EGR_{BP}).

These models enable to estimate the burnt gas fraction dynamics BGR_{dyn} and the air/fuel ratio dynamics AF_{ratio-dyn} from the quasi-static estimates and the estimated torque variation:

$${BGR}_{dyn} = f ( BGR , Cme , dCme / dt )$$

$${AF}_{ratio \text{-} dyn} = f ( {AF}_{ratio} , Cme , dCme / dt )$$

A correction coefficient Cor_{i-QS2TR} for each pollutant can be calculated as a function of these dynamic quantities:

$${Cor}_{i - QS 2 TR} = f ( {BGR}_{dyn} , BGR , {AF}_{ratio \text{-} dyn} , {AF}_{ratio} )$$

These correction coefficients allow the pollutant emissions at the engine outlet to be estimated by taking account of the transient phenomena. The pollutant emissions at the engine outlet can therefore be written with a formula of the type:

$${PSME}_{i} = {Cor}_{i - QS 2 TR} * PSM \text{?}$$

$$\text{?} \text{indicates text missing or illegible when filed}$$

PSMEᵢ represents the emissions of pollutant I at the engine outlet.

Aftertreatment Model

The aftertreatment model relates the pollutant and/or noise emissions at the engine outlet (i.e. before the aftertreatment system) to the pollutant and/or noise emissions at the aftertreatment system outlet, by means of at least one macroscopic parameter. According to an implementation of the invention, at least one of the following macroscopic parameters can be used to construct the engine model: displacement, vehicle homologation standard, etc.

The aftertreatment model can comprise submodels for each depollution technology and/or noise reduction submodels, which are associated according to the architecture of the vehicle depollution or noise reduction system. These submodels can be parametrized according to macroscopic vehicle parameters, such as homologation standard, displacement, etc. For example, for depollution, the various depollution technologies can be:
TWC: three-way catalytic converters,
GPF (for gasoline engines): gasoline particle filters,
DOC (for diesel engines): diesel oxidation catalysts,
DPF (for diesel engines): diesel particle filters,
LNT (for diesel engines): lean NOx traps,
SCR (for diesel engines): selective catalytic reduction.

The aftertreatment model allows to estimate the pollutant or noise emissions at the aftertreatment system outlet from the estimations of temperature, flow rate and pollutant emissions at the engine outlet. The aftertreatment model can be constructed by discretizing the aftertreatment system into several slots (or layers), and by association of the efficiency Conv_{i,j} of each discretized slot. According to an example, the aftertreatment model for pollutant emissions can be written as follows:

$${PSEE}_{i} = {\prod }_{j = 1}^{Nb pain} {Conv}_{i , j} ( Téch , Qéch ) * {PSME}_{i}$$

PSEEᵢ represents the emissions of pollutant i at the aftertreatment system outlet; Conv_{i,j} is the conversion efficiency of slot j of the aftertreatment system for pollutant i; Téch the exhaust gas temperature; Qéch the exhaust gas flow rate.

The efficiency of the aftertreatment system slots can be determined from maps provided by the manufacturer.

Determining Risks in Terms of Road Safety for Each Predetermined Vehicle

Road safety risks tend to define the hazardous condition of a part of a road network portion.

These road safety risks can notably be determined according to the road adhesion of vehicles.

Road adhesion can notably be characterized according to the slope profile and/or the speed profile of the road portion parts, the predetermined vehicles and the speeds, accelerations and decelerations on the road portion part. Adhesion may also depend on the curves of the road.

To determine the hazardous condition of a part of a road network portion, the road safety parameter at the end of step b) can be determined by carrying out the following steps: constructing a movement model for each predetermined vehicle considered of the predefined fleet; determining a slip parameter for each predetermined vehicle; determining a road safety parameter (corresponding to a physical characteristic at the end of step b)) for each predetermined vehicle.

Construction of the Vehicle Movement Model

The movement model of the predetermined vehicle is understood to be a model relating at least one (vehicle tyre) slip parameter to the position and/or the altitude of the vehicle of the slope profile.

The slope profile (obtained in step a)) is understood to be a curve representative of the variation or the spatial derivative of the altitude of the road network portion as a function of the positions (latitude and longitude for example) of the road network portion.

The model takes account of the vehicle movement dynamics (speed, acceleration, etc.) to determine the vehicle slippage, i.e. unwanted and uncontrolled movement of the vehicle.

The movement model of the predetermined vehicle can take account of at least one, preferably all of the following conditions: road condition, weather conditions, tyre pressure and wear of the predetermined vehicle, notably using a map. This map can notably relate the slip parameter to the tyre adhesion coefficient. Thus, the road safety parameter is more representative of the hazardous condition of the predetermined vehicle on the part of the road network portion considered.

A tyre slip parameter of the vehicle can be the sideslip angle of the predetermined vehicle, denoted by β. The sideslip angle corresponds to the angle formed between the speed vector of the vehicle and the longitudinal axis of the vehicle.

Another tyre slip parameter of the vehicle can be the longitudinal slip ratio, denoted by SR. The longitudinal slip ratio corresponds to the slipping behaviour of the wheel tyre with respect to the ground. This slip ratio notably depends on the ground adhesion coefficient of the tyre.

According to an embodiment, it is assumed that the wheels remain in contact with a flat ground. Furthermore, it is assumed that the suspensions are rigid, which allows roll and pitch to be disregarded.

For example, sideslip angle β can be determined at any instant by a formula of the type:

$$β = \frac{{v}_{fy} ( i ) + {v}_{ry} ( i )}{2 * {v}_{L} ( t )}$$

with
i: the calculation instant,
v_{fy}: the projection on axis y of the front wheel speed,
v_{ry}: the projection on axis y of the rear wheel speed, and
v_{L}: the projection on the longitudinal axis of the vehicle of the vehicle speed, the speed projections being a function of said vehicle position.

The following sequence of steps can be carried out to determine sideslip angle β:

### Calculation of the Front Wheel Steering Angle α

The calculation of the front wheel steering angle α is described in detail in this section.

The calculation of the yaw angle T from the coordinates (position) can be obtained at any instant i from the following equation:

$$ψ ( t ) = \frac{180}{π} * {tan}^{- 1} ( \frac{{x}_{GPS} ( t ) - {x}_{GPS} ( t - 1 )}{{y}_{GPS} ( t ) - {y}_{GPS} ( t - 1 )} )$$

with (x_{GPS}, Y_{GPS}): positions of the road network portion from the speed profile and/or the slope profile.

The angular speed co of the vehicle can be given, at any instant i, by a formula of the type:

$$ω ( t ) = \frac{ψ ( t ) - ψ ( t - 1 )}{{T}_{e}}$$

with Tₑ the sampling frequency.

The projections vₓ and v_{y} of speed v of the predetermined vehicle in the reference frame (x,y) can be given by:

$${v}_{x} ( t ) = \frac{{x}_{GPS} ( t ) - {x}_{GPS} ( t - 1 )}{{T}_{e}}$$

$${v}_{y} ( t ) = \frac{{y}_{GPS} ( t ) - {y}_{GPS} ( t - 1 )}{{T}_{e}}$$

The projections v_{L} and v_{T} of speed v in the vehicle reference frame can be given by:

v_{L}(t)=vₓ(t)*cos ψ(t)+v_{y}(t)*sin ψ(t)

v_{T}(t)=vₓ(t)*sin ψ(t)+v_{y}(t)*cos ψ(t)

The steering angle can then be calculated:

$$\text{?} ( t ) = {tan}^{- 1} ( \frac{ω ( t ) * ( {l}_{r} + {l}_{f} )}{{v}_{L} ( t )} )$$

$$\text{?} \text{indicates text missing or illegible when filed}$$

lᵣ being the distance between the centre of gravity and the rear wheel axle, and
l_{f} being the distance between the centre of gravity and the front wheel axle.

Calculation of Sideslip Angle β

The calculation of sideslip angle β is described in detail in this section. The method selected consists in taking the average of the sideslip angle of the front and rear wheels of each predetermined vehicle.

Projections v_{fy} and v_{ry} on axis y of front and rear wheel speeds v_{f} and vᵣ respectively are therefore calculated:

$${v}_{fy} ( t ) = ( {v}_{T} ( t ) + {l}_{f} * ω ( t ) ) * cos α ( t ) - {v}_{L} ( t ) * sin α ( t )$$

$${v}_{ry} ( t ) = {v}_{T} ( t ) - {l}_{r} * ω ( t )$$

β is deduced therefrom by an equation of the form:

$$β ( t ) = \frac{{v}_{fy} ( t ) + {v}_{ry} ( t )}{2 * {v}_{L} ( t )}$$

Thus, by combining the equations, a movement model relating sideslip angle β to the position of the predetermined vehicle on the road network portion is obtained for each predetermined vehicle.

The slip parameter can also comprise the longitudinal slip ratio SR determined by the vehicle movement model and by means of a map as a function of adhesion coefficient μ of the vehicle and of the weather conditions (road condition).

To characterize adhesion coefficient μ, the following steps can be carried out:

Calculation of Slope angle θ

The calculation of slope angle θ is described in detail in this section.

The distance Δd travelled at any instant i is given by:

Δd(t)=\sqrt{[x_{GPS}(t)=x_{GPS}(t−1)]²+[y_{GPS}(t)=y_{GPS}(t−1)]²}

The altitude variation Δh at any instant i can be simply calculated via the altitude obtained from the measurements:

$$Δ h ( t ) = {alt}_{GPS} ( t ) - {alt}_{GPS} ( t - 1 )$$

alt_{GPS} being the altitude at each position of the slope profile.

The instantaneous slope denoted by Slope can therefore be obtained:

$$Slope ( \text{?} ) = \frac{Δ h ( t )}{Δ d ( t )}$$

$$\text{?} \text{indicates text missing or illegible when filed}$$

Slope angle θ can be determined at any instant i by an equation of the form:

$$θ ( 1 ) = {tan}^{- 1} ( Slope )$$

Calculation of adhesion coefficient μ

Adhesion coefficient μ is calculated by calculating the traction force at the wheel-ground contact F_{driving} and the normal force of gravity F_{z}:

$${F}_{z} ( \text{?} ) = {M}_{vehicle} * g * cos ( θ ( \text{?} ) )$$

$$\text{?} \text{indicates text missing or illegible when filed}$$

M_{vehicle} being the mass of the vehicle and g the gravitational acceleration.

$${F}_{driving} ( t ) = {M}_{vehicle} * {α}_{veh} ( t ) + {M}_{vehicle} * g * sin ( θ ( t ) ) + {F}_{res} ( v ( t ) )$$

with aᵥₑₕ the instantaneous acceleration of the vehicle and Fᵣₑₛ the resultant of the frictional forces applied onto the vehicle, this resultant being given by the following relation, referred to as “road law”. This term is directly expressed as a function of the speed and characteristics of the vehicle.

$${F}_{res} ( v ) = {C}_{RR} + k * v + \frac{1}{2} * {ρ}_{air} * S * {C}_{x} * \text{?}$$

$$\text{?} \text{indicates text missing or illegible when filed}$$

with
ρₐᵢᵣ: air density
S: front surface of the vehicle
Cₓ: frontal aerodynamic drag coefficient of the vehicle
k: viscous friction coefficient
C_{RR}: rolling resistance coefficient of the vehicle.

The instantaneous acceleration of the vehicle aᵥₑₕ, can be obtained from the vehicle speed of the speed profile. For example, it can be estimated from an equation of the form:

$${α}_{veh} = \frac{v ( t ) - v ( t - 1 )}{{T}_{e}}$$

Adhesion coefficient μ can be deduced by an equation of the type:

$$μ ( i ) = \frac{{F}_{driving} ( t )}{\text{?} ( t )}$$

$$\text{?} \text{indicates text missing or illegible when filed}$$

Thus, by combining the equations, a vehicle movement model relating the adhesion coefficient to the vehicle position and altitude of the slope profile is obtained, then longitudinal slip ratio SR is deduced therefrom by means of a map.

The method according to the invention is not limited to the movement model described below, other models may be used, notably models taking account of the vehicle width.

Determination of a Slip Parameter

At least one vehicle slip parameter can be determined by means of the movement model constructed above and of the speed and slope profiles of step a) of the method according to the invention, and the slip parameter can comprise sideslip angle β and/or longitudinal slip ratio SR.

From the sideslip angle β thus determined, the tyre slip is characterized by means of a map depending on two parameters: adhesion coefficient μ and the determined sideslip angle β. This map can depend on the road condition, in particular it is very different depending on whether the road is dry or wet (which can be estimated from the weather forecast), and on the condition of the tyres, the pressure and wear thereof.

Determining an Indicator of Hazardous Driving Conditions

At least one road safety parameter is determined from the slip parameter(s) determined in the previous step. The road safety parameter can take the form of a value, a grade, etc.

The road safety parameter can be determined by carrying out the following steps:

selecting at least one hazardous condition threshold (at least one threshold per parameter) for the slip parameter(s) or their derivatives,

determining whether the slip parameter(s) or their derivatives exceed the selected threshold,

quantifying the number of times and/or the frequency (in time or kilometers) with which the slip parameter(s) or their derivatives have exceeded the selected threshold, and

deducing from this number and/or frequency the road safety parameter.

Indeed, comparing the slip parameters (or their derivatives) with thresholds allows to determine whether the driver often encounters limit adhesion conditions that increase the road safety risks.

The road safety parameter can be the number of times or the frequency with which the threshold has been exceeded. Alternatively, the indicator may be an average value or a grade (out of 10 for example) representative of the various numbers of times and/or frequencies calculated for each slip parameter.

Other methods of determining road safety risks could be used. These methods could notably take account of the engine model, already defined, the transmission to the wheels of the system and/or the braking system with optional correction using an aftertreatment device (of ABS type for example). Thus, it is possible for example to add a vehicle model, a transmission system model, a braking system model and optionally an aftertreatment model.

The invention also relates to a computer program product downloadable from a communication network and/or recorded on a computer-readable medium and/or processor or server executable, comprising program code instructions for implementing the method according to any one of the above features, when said program is executed on a computer, a mobile phone or a computer device. Implementation of the method therefore is simple and fast.

The invention further relates to the use of the method according to one of the features described above for modifying the road infrastructure, extending the public transport network and/or modifying the road traffic control measures. Indeed, the method is particularly suited for comparing the various technical options and thus finding an optimum compromise as regards pollutant and noise emissions and/or road safety risks. Furthermore, the method avoids costs related to work completion and a posteriori analyses after work completion in order to assess the impact of the modifications. It allows the impact of such changes to be anticipated.

Implementation of the method can therefore notably comprise the following steps:

carrying out the steps of the method as described above for the existing road network portion so as to determine the physical parameters representative of the pollutant and/or noise emissions and/or the road safety risks,

carrying out the steps of the method as described above with at least one infrastructure or development modification (addition of a traffic light in a given position, addition of a roundabout, limitation of or increase in the number of lanes of the road network portion, in order to add a bus or tram lane for example, maximum speed modification on the road network portion) so as to determine, for each configuration (i.e. each infrastructure or development modification and for the existing initial road network portion), the physical parameters representative of the pollutant and/or noise emissions and/or the road safety risks,

determining the optimum configuration (for example, the configuration enabling to reduce pollutant emissions as far as possible or to reduce the noise to the maximum),

performing works on the road network portion for the physical installation of the optimum configuration (for example, development of a roundabout, addition or removal of a traffic light, addition or removal of traffic lanes, addition of speed limit signs).

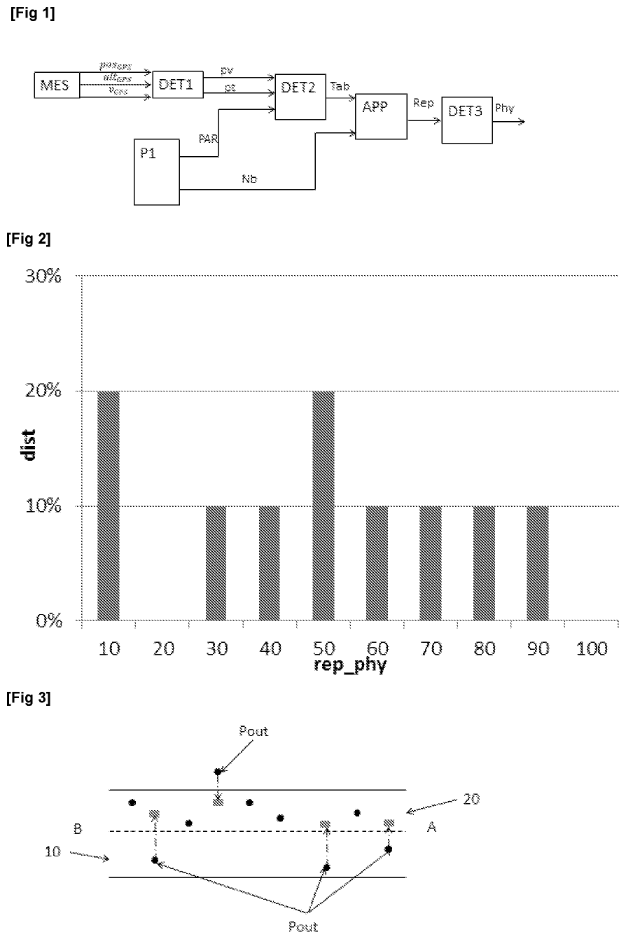

FIG. 1 schematically illustrates, by way of non-limitative example, an embodiment of the method according to the invention.

In this method, the following steps are carried out, preferably successively:

a) measuring MES the positions pos_{GPS}, speeds v_{GPS} and altitudes alt_{GPS} with a measuring means such as, for example, GPS devices on board vehicles travelling along the road network portion. These measurements can also be recorded in a FCD system. A speed profile pv and a slope profile pt are determined DET1 on the road network portion from these measurements. Positions pos_{GPS}, speeds v_{GPS} and altitudes alt_{GPS} are measured for several rides of vehicles travelling along the road network portion, preferably at least one hundred rides so as to have enough data for determining, in a precise and reliable way, speed profile pv and slope profile pt. Indeed, with fewer rides, the method can still be implemented but the confidence parameter will be of lower quality. Indeed, with a small number of rides, between 2 and 10 for example, the reliability of the speed profile determined could be lower, which is characterized by a lower confidence parameter. On the other hand, from one hundred recorded rides, the speed profile is reliable and the confidence parameter is improved. The vehicles used to measure positions pos_{GPS}, speeds v_{GPS} and altitudes alt_{GPS} preferably are of different types and they are not necessarily the predetermined vehicles of the predefined fleet. In other words, the vehicles used for these measurements can be any motor vehicle and the measurements are preferably performed from different vehicle types, as inertia and speed may for example influence accelerations/decelerations, in order to have a representative speed profile pv and slope profile pt. The speed profile thus obtained is sufficient to determine with precision the pollutant and noise emissions, and the road safety risks,
b) determining DET2 for each vehicle of a predefined fleet P1, each of these vehicles being not necessarily related to the vehicles used for the measurements of step a), at least one physical characteristic representative of the pollutant emissions (amount of NOx emissions, amount of CO₂ emissions, amount of PM2.5 particulate matter for example), the noise emissions (noise level) and/or the risks in terms of road safety (road adhesion of the vehicle for example) over at least part of said road network portion. Each physical characteristic is determined according to the characteristics PAR of the vehicles taken into account from the predefined fleet P1, and to the speed profile pv and slope profile pt determined in step a). The speed profile pv and the slope profile pt taken into account for these calculations are therefore always the same, whatever the vehicle considered for the next steps. Although the speed profile pv considered is determined for the next steps (steps b) to d)), it could be interesting to modify speed profile pv by modifying the speed profile determination in step a). For example, to determine speed profile pv, a single time slot could be considered, a particular day of the week, for example Tuesday between 7 am and 9 am. Determination of the pollutant and noise emissions and/or of the impact thereof on the road safety could thus be refined, and the precision therefore improved. The different values of the physical characteristics thus depend on the characteristics PAR of the vehicles. At the end of step b), a physical characteristics table Tab is obtained, each physical characteristic of table Tab corresponding to a vehicle of predefined fleet P1,
c) applying APP predefined fleet P1 to the table Tab of physical characteristics determined in the previous step to obtain a distribution Rep of the physical characteristics on predefined fleet P1. Each of the physical characteristics of table Tab is therefore multiplied by the number Nb (or the percentage) of vehicles corresponding to this value in predefined fleet P1. A distribution Rep of the physical characteristics according to the vehicles of predefined fleet P1 and to the number Nb (or the percentage) of each of these vehicles in predefined fleet P1 is thus obtained,
d) determining DET3 the physical parameter Phy on at least part of said road network portion by means of physical characteristics distribution Rep obtained in step c). The physical characteristics distribution Rep obtained in step c) is therefore aggregated. For example, for this aggregation, the physical parameter can be taken as the value of distribution Rep corresponding to the sixtieth percentile of distribution Rep. This aggregation operation allows to switch from a plurality of physical characteristics in distribution Rep to a single scalar of physical parameter Phy, for each criterion observed (pollutant, noise emissions and/or road safety risks). In other words, at the end of step d), each part of the road network portion is characterized by several physical parameters, each being a scalar value, and the physical parameters may be, for example, the amount of NOx emissions, the amount of CO₂ emissions, the amount of PM2.5 particulate matter, the level of noise emissions, the road adhesion.

The method thus allows to determine physical parameters of road network portions for a predefined vehicle fleet P1.

FIG. 2 schematically shows, by way of non-limitative example, a physical characteristics distribution rep_phy according to the distribution dist of each of these physical characteristics (the level of noise emissions in dB for example). Distribution dist is directly related to the number of vehicles of each type considered (each predetermined vehicle) in the fleet. Thus, the calculated physical characteristics can correspond to 10, 20, 30, 40, 50, 60, 70, 80 and 90. Values 10 and 50 correspond to vehicles representing each 20% of the fleet, and each of values 30, 40, 60, 70, 80 and 90 correspond to vehicles representing each 10% of the fleet considered. Value 20 is not represented. Thus, the sixtieth percentile will correspond to value 50 of the physical characteristics distribution rep_phy. Indeed, the values less than or equal to 50 are 10, 20, 30, 40 and 50, respectively represented by 20%, 0%, 10%, 10% and 20% of the fleet vehicles. Thus, the values less than or equal to 50 indeed represent 60% of the fleet considered. Therefore, the physical parameter that is aggregated in step d), by aggregating at the sixtieth percentile, is 50. For example, it could then be considered that the noise level of the road network portion part is therefore 50 dB for the vehicle fleet considered.

FIG. 3 illustrates a spatial aggregation. In this figure, a road 10 is represented by the two black solid lines. This road is a two-lane road, the two lanes being separated by the dotted line. Each lane allows traffic in one direction. In other words, one of the lanes allows to travel from A to B and the other from B to A. Lane 20 allows to travel from A to B. The position of a vehicle travelling from A to B is measured at an acquisition frequency of 1 Hz. The measuring points correspond to the black dots. It is observed that some of these points Pout are placed outside the space contained between the upper black solid line and the dotted line, delimiting lane 20. These points Pout are then aggregated, i.e. corrected to be moved artificially back into the space of lane 20 delimited by the upper solid black line and the dotted line. The aggregation step thus consists in correcting the measured points to bring them back into the space considered. The dash-dot arrows represent the corrections performed on each of these points Pout and the grey rectangles represent the corrected measuring points.

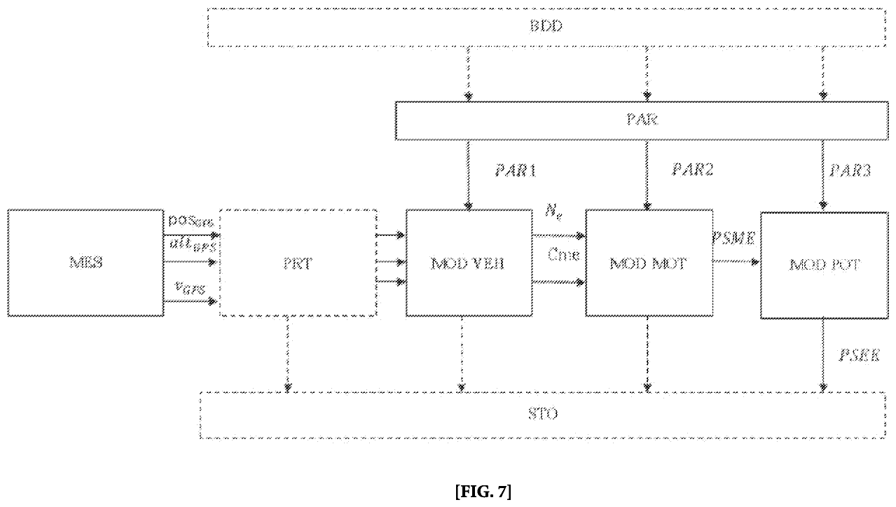

FIG. 7 schematically illustrates, by way of non-limitative example, an embodiment of step b) of the method according to the invention. In this figure, the dotted lines indicate optional elements of the method.

Prior to this step b), the various models (vehicle model MOD VEH, engine model MOD MOT and aftertreatment model MOD POT) are constructed. These models are constructed from macroscopic parameters PAR. Optionally, macroscopic parameters PAR can be obtained from a database BDD that lists the various vehicles in service. For example, macroscopic parameters PAR can be obtained by means of the registration number of the predetermined vehicles of the predefined fleet, of database BDD associating the number plate with the design of the vehicle (make, model, engine type, etc.) and comprising the macroscopic parameters of the predetermined vehicles.

A first series of macroscopic parameters PAR1 is used for constructing the vehicle model MOD VEH. This first series of macroscopic parameters PAR1 can comprise the following parameters: vehicle mass, maximum power and associated engine speed, maximum speed, transmission type (non-limitative list). Each of these parameters depends on each predetermined vehicle.

A second series of macroscopic parameters PAR2 is used for constructing the engine model MOD MOT. This second series of macroscopic parameters PAR2 can comprise the following parameters: displacement, engine type, maximum torque and power, air loop architecture, vehicle homologation standard (non-limitative list). Each of these parameters depends on each predetermined vehicle.

A third series of macroscopic parameters PAR3 is used for constructing the aftertreatment model MOD POT. This third series of macroscopic parameters PAR3 can comprise the following parameters: displacement, vehicle homologation standard (non-limitative list). Each of these parameters depends on each predetermined vehicle.

From speed profile pv and slope profile pt determined in step a) of the method, the engine torque and speed are determined from vehicle model MOD VEH, which determines torque Cme and speed Ne of the engine, according to the speed profile and preferably according to the slope profile. Each predetermined vehicle has a specific vehicle model MOD VEH.

The pollutant and/or noise emissions at the engine outlet can then be determined, by means of engine model MOD MOT that determines the pollutant and/or noise emissions at the engine outlet PSME, according to torque Cme and speed Ne of the engine. The engine considered depends on each predetermined vehicle.

It is then possible to determine the pollutant and/or noise emissions of the vehicle, i.e. at the outlet of the aftertreatment system, by means of aftertreatment model MOD POT, which determines the pollutant and/or noise emissions at the aftertreatment system outlet PSEE, according to the pollutant and/or noise emissions at the engine outlet PSME. The pollutant and/or noise emissions can be determined at any instant, at a frequency of 1 Hz for example. The aftertreatment system considered depends on each predetermined vehicle.

Optionally, this data can then be stored, in full or in part. Once the pollutant and/or noise emissions of the predetermined vehicles PSEE are characterized, they can be stored STO (recorded), in particular in a database (different from the database comprising the macroscopic parameters). This storage STO may concern only the pollutant and/or noise emissions of the predetermined vehicles PSEE, but it may also concern intermediate data: torque Cme and speed Ne of the engine and/or the pollutant and/or noise emissions at the engine outlet PSME. This information enables monitoring of the real uses and of the associated emissions, with a good spatial and temporal resolution. This information can for example allow to assess the environmental relevance of the road infrastructures at street scale, to identify localized emission peaks, to identify the impact of the driving style on emissions, etc.

### Examples

FIGS. 4 to 6 compare examples of pollutant emissions determination (amount of NOx emissions) on the same road network portion in metropolitan Lyon, the road network portion extending over about 150 m.

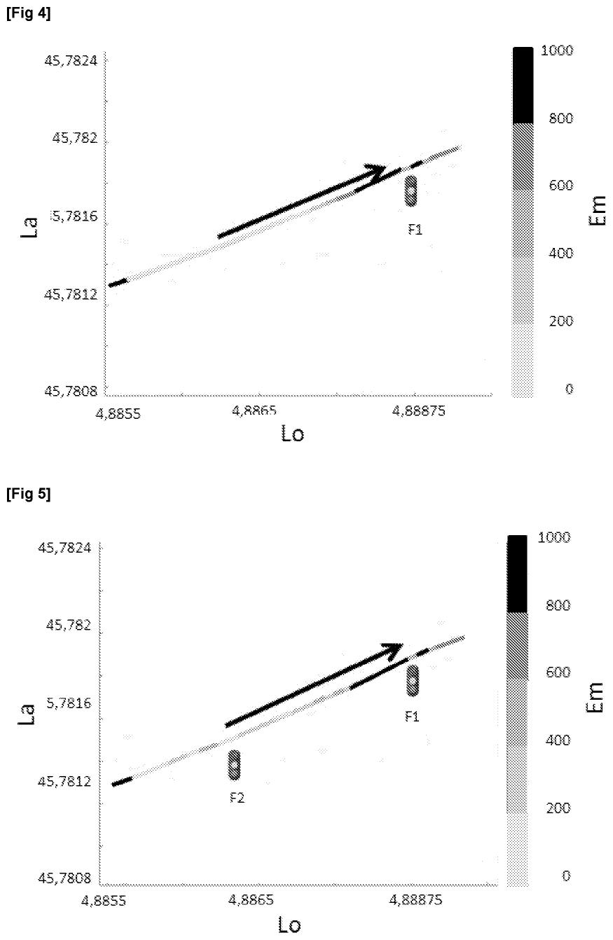

FIGS. 4 and 5 show the difference between before and after the addition of a traffic light on the road network portion considered. They show maps of the pollutant emissions Em on a road map defined by the longitude Lo in degrees on the x-axis and the latitude La in degrees on the y-axis. The pollutant emissions are identified with a grey level between 0 and 1000 mg/km road.

FIG. 4 shows the NOx emissions determined with the method of FIG. 1 according to the invention before addition of the traffic light. The road network portion comprises a first traffic light F1 before the addition of the second traffic light.

FIG. 5 shows the NOx emissions determined with the method of FIG. 1 according to the invention after the addition of traffic light F2, traffic light F2 being located about 100 m upstream from traffic light F1. FIG. 5 thus comprises two traffic lights, F1 already initially present before the modification (identical to that in FIG. 4) and F2 that has been added. The speed and slope profiles for determining the pollutant emissions of the maps shown in FIGS. 4 and 5 have been determined by means of the position, speed and altitude measurements collected with the Geco Air™ application (1 Hz FCD). Within the context of these examples of the invention, the traffic light is positioned at a crossroads on the avenue Roger Salengro in Villeurbanne, at the intersection with the rue de Longchamp. Traffic light F2 is positioned in FIG. 5. The purpose of this traffic light was to slow down the traffic speed and to make the area quieter and safer for the passers-by and the residents.

However, as can be seen in FIG. 5, by comparison with FIG. 4, upstream (in the direction of the black arrow showing the direction of traffic flow) from added traffic light F2, the presence of traffic light F2 increases the rate of NOx emissions by about 25%. This is mainly due to the phase of stopping at red light F2, and therefore to the acceleration and deceleration phases imposed by traffic light F2.

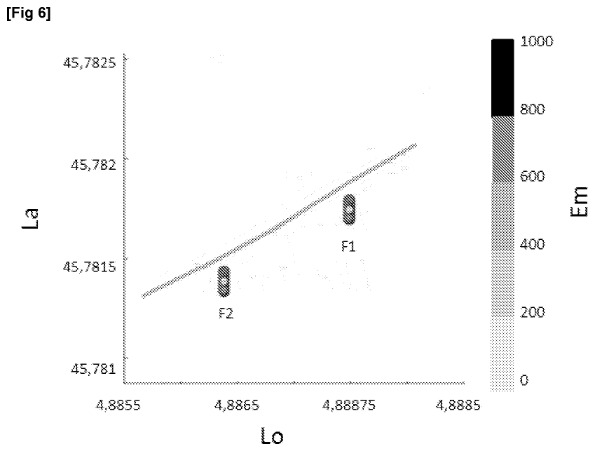

FIG. 6 shows an example of determining pollutant emissions on the same road network portion as in FIGS. 4 and 5, according to the COPERT method of the prior art. This method is based on the average speed over long parts of the road network (at least 1 km). Thus, the presence or not of traffic lights F1 and/or F2 has no impact on the method. This means that FIG. 6 corresponds as well to the application of the COPERT method with a single traffic light (traffic light F1 of FIG. 4) as to the application of the COPERT method with two traffic lights (traffic lights F1 and F2 of FIG. 5), and even to a variant without traffic lights. According to the COPERT method, there would thus be no difference between these various situations, and the method does not enable to discretize the road network portions, traffic lights F1 and F2 for example. This method therefore does not allow to precisely view the local impact of pollutant emissions or to determine precisely in space the pollutant emissions. On the other hand, FIGS. 4 and 5 enable local discretizations of the pollutant emissions, which provides fine determination of the position of the most polluted areas and assessment of the impact, in terms of pollution, of new infrastructures or new regulations on a part of the road network.

1. A method of determining physical parameters (Phy) relative to pollutant and/or noise emissions and/or road safety of a predefined fleet (P1) of predetermined vehicles on a road network portion, the method using at least one means of measuring positions (pos_{GPS}), speeds (v_{GPS}) and altitudes (alt_{GPS}) on the road network portion, characterized in that the following steps are carried out:
a) measuring (MES) at least positions (pos_{GPS}), speeds (v_{GPS}) and altitudes (alt_{GPS}) using the at least one measuring means on the road network portion and determining (DET1) a speed profile (pv) on the road network portion,
b) determining (DET2) at least one physical characteristic (Tab) on at least part of the road network portion for each of the predetermined vehicles of the predefined fleet, according to the characteristics (PAR) of the predetermined vehicles and to speed profile (pv) thus determined,
c) applying (APP) the predefined fleet (P1) to the physical characteristics (Tab) determined in the previous step to obtain a distribution (Rep) of the physical characteristics on the predefined fleet,
d) determining (DET3) the physical parameter (Phy) on at least the part of the road network portion by means of the distribution (Rep) of the physical characteristics obtained in step c).

2. A method as claimed in claim 1, wherein a spatial aggregation of measured positions (pos_{GPS}) is performed.

3. A method as claimed in claim 2, wherein the spatial aggregation comprises correction of measured positions (pos_{GPS}) so as to correspond to positions of the road network portion.

4. A method as claimed in claim 1, wherein the road network portion is divided into segments of predetermined length, and steps b), c) and d) are carried out on each of the segments of predetermined length.

5. A method as claimed in claim 1 wherein, in step d), the physical parameter (Phy) is determined on at least the road network portion by aggregating the distribution (Rep) of the physical characteristics obtained in step c).

6. A method as claimed in claim 5 wherein, when the aggregation of distribution (Rep, rep_phy) of the physical parameters is performed, the physical parameter (Phy) is taken as the value of the distribution (Rep, rep_phy) of the physical characteristics corresponding to a predetermined quantile, the predetermined quantile preferably being the sixtieth percentile.

7. A method as claimed in claim 1, wherein the physical parameter (Phy) comprises the amount of NOx emissions (Em), the amount of PM2.5 particulate matter emissions, the amount of greenhouse gas emissions, the noise emissions and/or a variable representative of the impact on road safety of the part of the road network portion, preferably the variable representative of the impact on road safety being the adhesion to the part of the road network portion.

8. A method as claimed in claim 1, wherein the characteristics of the predetermined vehicles comprise the mass of the vehicles, the engine type and the exhaust gas aftertreatment type.

9. A method as claimed in claim 1, wherein a traffic stream is applied, the traffic stream preferably comprising the flow of vehicles on the road network portion, according to the day and the time of day considered.

10. A method as claimed in claim 1, wherein the physical parameter (Phy) is displayed on a road map, preferably by means of a smartphone, a computer, a digital tablet or a computer system.

11. A method as claimed in claim 10, wherein the physical parameter (Phy) is displayed on a road map for a configuration chosen by the user, and the configuration can comprise the physical parameter (Phy) to be displayed, the predefined fleet (P1) of predetermined vehicles, the sensitivity level of the physical parameter, the predetermined quantile and/or the traffic stream.

12. A method as claimed in claim 1, wherein a confidence parameter is determined for the physical parameter.

13. A method as claimed in claim 1 wherein, in step b), for each predetermined vehicle, at least one characteristic of the predetermined vehicle (PAR) relative to the design of the vehicle is acquired and the following models are constructed for the vehicle:
i) a model of the vehicle (MOD VEH) relating at least the speed profile to the torque and the speed of the engine by means of at least one characteristic of the predetermined vehicle (PAR),
ii) a model of the engine (MOD MOT) relating the torque and the speed of the engine to the pollutant and/or noise emissions at the outlet of the engine by means of at least one characteristic of the predetermined vehicle (PAR), and
iii) a model of the aftertreatment system (MOD POT) relating the pollutant and/or noise emissions at the outlet of the engine to the pollutant and/or noise emissions at the outlet of the aftertreatment system by means of at least one characteristic of the predetermined vehicle (PAR),
and the torque (Cme) and the speed (Ne) of the engine are determined by means of the vehicle model (MOD VEH) and the speed profile (pv); the pollutant (Em) and/or noise emissions at the outlet of the engine (PSME) are determined by means of the engine model (MOD MOT) and the torque (Cme) and the speed (Ne) of the engine; and the pollutant (Em) and/or noise emissions of the vehicle (PSEE) are determined by means of the aftertreatment system model (MOD POT) and the pollutant (Em) and/or noise emissions at the outlet of the engine (PSME), the physical characteristics being the pollutant (Em) and/or noise emissions at the aftertreatment system outlet.

14. A computer program product downloadable from a communication network and/or recorded on a computer-readable medium and/or processor or server executable, comprising program code instructions for implementing the method as claimed in any one of the previous claims, when the program is executed on a computer, a mobile phone or a computer device.

15. Use of the method as claimed in claim 1 for modifying the road infrastructure, extending the public transport network and/or modifying the road traffic control measures.
